(19) United States
(12) Patent Application Publication
(10) Pub. No.: US 2026/0257322 A1
(43) Pub. Date: Sep. 3, 2026

(54) POWER TOOL AND IMPACT MECHANISM

(71) Applicant: Black & Decker Inc., New Britain, CT (US)

(72) Inventors: Xiaojie Wang, Suzhou City (CN); Tong Zheng, Suzhou (CN); Yuming Zhou, Yangzhou city (CN); Yiqing Fan, Haimen City (CN)

(21) Appl. No.: 19/651,082

(22) Filed: Apr. 17, 2026

Related U.S. Application Data
(63) Continuation of application No. PCT/CN2023/125349, filed on Oct. 19, 2023.

(51) Int. Cl. B25B 21/02; B25B 23/00

(52) U.S. Cl. CPC B25B 21/026; B25B 23/0035

(57) ABSTRACT

A power tool comprises a housing and a motor having a drive shaft mounted in the housing. An impact mechanism is mounted in the housing and coupled to a tool holder. The impact mechanism comprises a rotatable hammer operatively connected to the drive shaft and having at least one hammer surface. The impact mechanism also comprises a rotatable anvil connected to the tool holder and having at least one anvil surface configured to be struck by the at least one hammer surface in a direction of rotation. The at least one anvil surface or the at least one hammer surface is moveable with respect to the other of the at least one hammer surface or the at least one anvil surface in a radial direction perpendicular to the direction of rotation.

### CROSS REFERENCE TO RELATED APPLICATION

This application claims priority to, and is a continuation of, PCT/CN2023/125349, filed on October 19, 2023 and entitled “A power tool and impact mechanism,” which is hereby incorporated by reference in its entirety.

### FIELD

The present disclosure relates to a power tool. In particular the present disclosure relates to a power tool with an impact mechanism.

### BACKGROUND

Impact drivers can provide a high torque to a tool holder in order to drive a fastener into a material. One known impact driver is shown in US 2021/0060741 which comprises a motor connected to a hammer which strikes an anvil. The hammer is mounted on a coil spring which urges the hammer frontward towards the anvil. The anvil comprises a pair of blades which are configured to engage with tabs on the hammer. When the anvil receives more torque under further fastening, the hammer retracts against the urging force from the coil spring. When the tabs are disengaged from the blades, the hammer advances while rotating along a cam groove under the urging force from the coil spring. Then, the tabs are re-engaged with the blades to cause the anvil to produce a rotational striking force e.g. an impact.

This arrangement means that the hammer and anvil are arranged longitudinally along the axis of rotation of the power tool. This means that the power tool can be hard to fit into confined spaces.

### SUMMARY

Examples of the present disclosure aim to address the aforementioned problems.

According to an aspect of the present disclosure there is a power tool comprising: a housing; a motor having a drive shaft mounted in the housing; an impact mechanism mounted in the housing and coupled to a tool holder; the impact mechanism comprising: a rotatable hammer operatively connected to the drive shaft and having at least one hammer surface; and a rotatable anvil connected to the tool holder and having at least one anvil surface configured to be struck by the at least one hammer surface in a direction of rotation; wherein the at least one anvil surface or the at least one hammer surface is moveable with respect to the other of the at least one hammer surface or the at least one anvil surface in a radial direction perpendicular to the direction of rotation.

Optionally, the rotatable hammer comprises a rotatable sleeve.

Optionally, the at least one hammer surface is mounted on an inner surface of the rotatable sleeve.

Optionally, the rotatable anvil comprises a cylindrical body portion rotatably mountable within the rotatable sleeve.

Optionally, the at least one anvil surface is mounted on an outer surface of the cylindrical body portion.

Optionally, the rotatable hammer comprises a plurality of hammer surfaces circumferentially spaced around the rotatable hammer.

Optionally, the rotatable anvil comprises a plurality of anvil surfaces circumferentially spaced around the rotatable anvil.

Optionally, the impact mechanism comprises the same number of hammer surfaces and anvil surfaces.

Optionally, the rotatable anvil comprises at least one anvil slider having the at least one anvil surface.

Optionally, the at least anvil slider is mounted in a recess in the rotatable anvil.

Optionally, the at least anvil slider is configured to move from a first position in the path of the at least one hammer surface to a second position remote from the path the at least one hammer surface such that the at least one hammer surface moves with respect to the at least one anvil surface.

Optionally, the at least anvil slider in the second position is closer to the rotation axis of the rotatable anvil than in the first position.

Optionally, the at least one anvil slider comprises at least one spring configured to bias the at least one anvil slider towards the first position.

Optionally, the at least one hammer surface and / or the at least one anvil surface are inclined with respect to the direction of rotation.

Optionally, the impact mechanism is operable in an impact mode whereby the at least one anvil surface or the at least one hammer surface moves with respect to the other of the at least one hammer surface or the at least one anvil surface in a radial direction perpendicular to the direction of rotation and a drill mode whereby the at least one anvil surface engages the at least one hammer surface and the rotatable hammer and rotatable anvil rotate together.

Optionally, the impact mechanism is configured to operate in the impact mode when the torque on the tool holder exceeds a predetermined torque threshold.

In another aspect of the disclosure, there is provided an impact mechanism for a power tool comprising: a rotatable hammer operatively connectable to a drive shaft of a power tool motor and having at least one hammer surface; and a rotatable anvil connectable to a tool holder and having at least one anvil surface configured to be struck by the at least one hammer surface in a direction of rotation; wherein the at least one anvil surface or the at least one hammer surface is moveable with respect to the other of the at least one hammer surface or the at least one anvil surface in a radial direction perpendicular to the direction of rotation.

### BRIEF DESCRIPTION OF THE DRAWINGS

Various other aspects and further examples are also described in the following detailed description and in the attached claims with reference to the accompanying drawings, in which:

FIG. 1 shows a cross-sectional side view of a power tool according to an example;

FIG. 2 shows a partial perspective view of an impact mechanism of the power tool according to an example;

FIGS. 3 and 4 respectively show a plan view and a perspective view of a rotatable anvil of an impact mechanism of a power tool according to an example;

FIGS. 5 and 6 respectively show a front view and a perspective view of a rotatable hammer of an impact mechanism of a power tool according to an example;

FIGS. 7 and 8 respectively show a perspective view and an end-on view of an anvil slider of a rotatable anvil according to an example;

FIGS. 9 and 10 respectively show a side cross-sectional view and a front cross-sectional view of an assembled impact mechanism of a power tool according to an example;

FIGS. 11 and 12 respectively show a side cross-sectional view and a front cross-sectional view of an assembled impact mechanism of a power tool according to an example;

FIGS. 13a, 13b, and 13c show a front view of an impact mechanism of a power tool in a first mode according to an example;

FIGS. 14a, and 14b show a front view of an impact mechanism of a power tool in a second mode according to an example;

FIG. 15 shows a front view of an impact mechanism of a power tool according to another example; and

FIGS. 16 shows a front view of an impact mechanism of a power tool according to yet another example.

### DETAILED DESCRIPTION

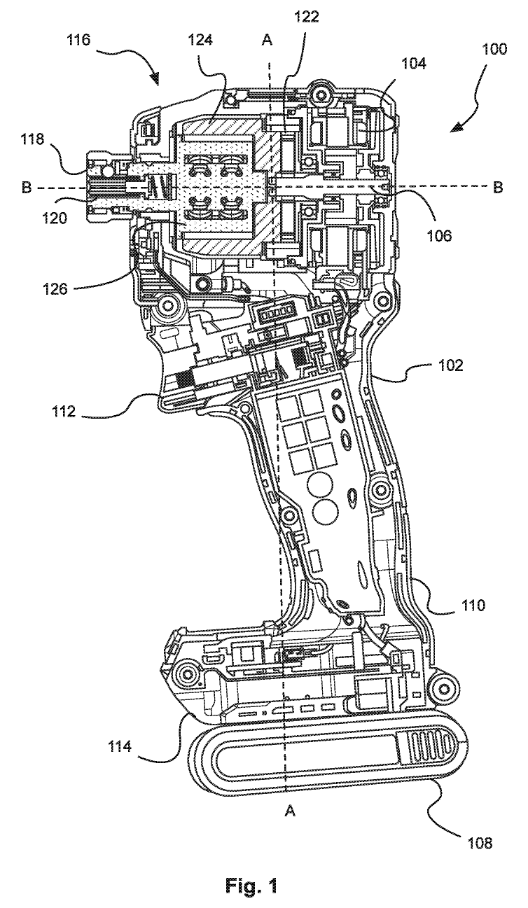

FIG. 1 shows a cross-sectional side view of a power tool 100 having a housing 102 which extends along a longitudinal axis A-A. The housing 102 in some examples comprises a clam shell construction which is fastened together with screws or other suitable fastenings.

The power tool 100 comprises a motor 104 having a drive shaft 106. The motor 104 is electrically connected to a battery pack 108 which is connected to a bottom portion of a handle 110 via a battery connector portion 114 at the second end 106. The battery connector portion 114 comprises mechanical and electrical connectors for mounting the battery pack 112 to the housing 102. The battery pack 112 in some examples is removable from the housing 102. When the battery pack 112 is mounted to the housing 102, the battery pack 112 is mechanically connected to the housing 102 and electrically connected to an electrical circuit comprising the motor 104. In some other examples, the battery pack 112 can be integral with the housing 102 and not removable from the housing 102.

A trigger switch 112 is mounted in the handle 110 and configured to selectively actuate the motor 104.

Whilst the examples described in reference to FIG. 1 are battery powered, in other examples other power sources can be used. For example, the motor 104 can be powered from a mains electricity source. In some other examples, the motor 104 can be powered from a compressed air source e.g., the motor 104 is a pneumatic motor or from a hydraulic pump e.g., the motor 104 is a hydraulic motor. In these examples (not shown) an electrical cable, a pneumatic hose or a hydraulic hose is connected to the power tool 100. Any suitable power source can be used together with a compatible motor 104.

The drive shaft 106 of the motor 104 as shown in FIG. 1 is configured to rotate about a rotation axis B. In some examples, the drive shaft 106 is operatively connected to an impact mechanism 116 which is also configured to rotate about the rotation axis B-B. The impact mechanism 116 is coupled to a tool holder 118 and configured to transmit torque to the tool holder 118 and a tool (not shown) in the tool holder 118. The tool holder 118 can comprise a square, hexagonal recess 120 for receiving a tool for engaging with fasteners. The tool holder 118 in some examples can provide quick release engagement with a tool bit or a socket. The tool holder 118 is known and will not be discussed in any further detail.

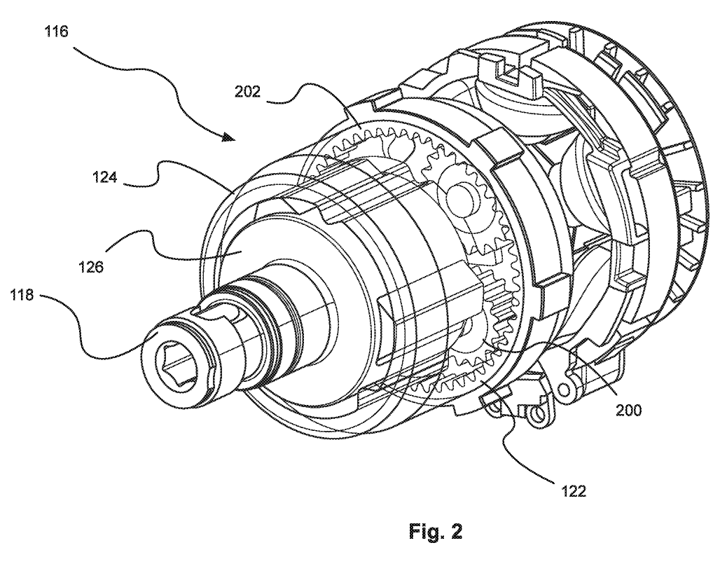

The impact mechanism 116 in some examples is coupled to the drive shaft 106 via a gearing 122. In some examples, the gearing 122 comprises a planetary gearing (best shown in FIG. 2) with a plurality of planet gears 200, a ring gear 202 and a sun gear (not shown). FIG. 2 shows a partial perspective view of the impact mechanism 116 of the power tool 100. Part of the power tool 100 is cut away for the purposes of clarity. The sun gear is fixed to the drive shaft 106 of the motor 104. In some other examples, the gearing 122 is another type of gearing. Alternatively in a less preferred example, there is no gearing and the drive shaft 106 of the motor 104 is connected directly to the impact mechanism 116.

The impact mechanism 116 comprises a rotatable hammer 124 and a rotatable anvil 126. The rotatable hammer 124 is connected to the ring gear 202 of the gearing 122. Therefore, when the motor 104 is actuated, the ring gear 202 rotates and causes rotation of the rotatable hammer 124 about the rotation axis B-B.

The rotatable hammer 124 is shown in FIGS. 5 and 6. FIGS. 5 and 6 respectively show a front view and a perspective view of the rotatable hammer 124. The rotatable hammer 124 comprises a sleeve portion 300 defining an internal hammer recess 302. The internal hammer recess 302 provides a cam surface 520 for guiding at least one anvil slider 402. The anvil slider 402 will be discussed in more detail below. The rotatable hammer 124 further comprises a hammer connection end 304 configured to be connected to the ring gear 202. The rotatable hammer 124 is rotatable about the rotation axis B-B. The rotatable hammer 124 in some examples is fixed to the ring gear 202 and rotates together with the ring gear 202 about the rotation axis B-B. The rotatable hammer 124 comprises an open bore 306.

The rotatable anvil 126 is also rotatable about the rotation axis B-B. The rotatable anvil 126 and the rotatable hammer 124 are concentrically aligned with the rotation axis B-B. The rotatable anvil 126 in some examples comprises an anvil body portion 308 which is configured to be received within the internal hammer recess 302. An anvil end portion 310 is configured to be inserted into the open bore 306. The rotatable anvil 126 is configured to rotate with respect to the rotatable hammer 124 under certain operating conditions which will be discussed in further detail below.

The anvil body portion 308 is connected to the tool holder 118. In this way, the tool holder 118 is configured to rotate together with the rotatable anvil 126. Similarly, the tool holder 118 is configured to also rotate about the rotation axis B-B.

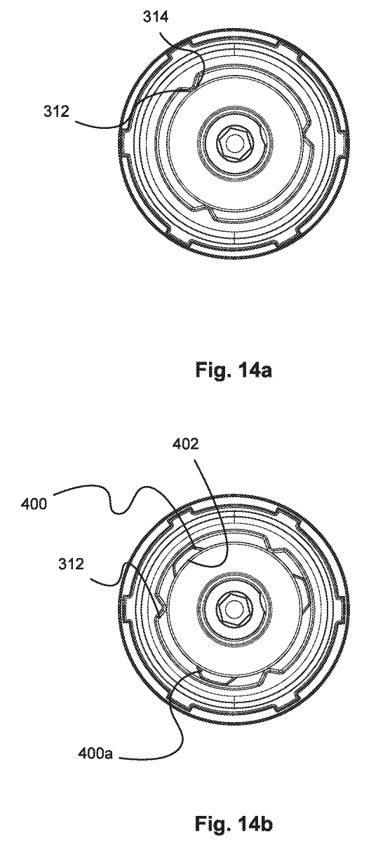

In order for the impact mechanism 116 to generate an impact torque and transmit the impact torque to the tool holder 118, the rotatable hammer 124 is configured to strike the rotatable anvil 126. Accordingly, the rotatable hammer 124 comprises a plurality of hammer surfaces 312. The rotatable hammer 124 comprises a plurality of elongate ridges 314 which extend along an internal surface 316 of the sleeve portion 300. The hammer surfaces 312 are disposed on a leading edge of the elongate ridges 314 in the rotation direction C (best shown in FIG. 13a and FIG. 5), which is anticlockwise as shown in FIG. 5. The elongate ridges 314 in some examples extend in a direction parallel with the rotation axis B-B. However, in some other examples, the elongate ridges 314 may be inclined with respect to the rotation axis B-B. In this case where the elongate ridges 314 may be inclined with respect to the rotation axis B-B, then the elongate ridges 314 are parallel with the anvil slider 402. The hammer surfaces 312 face the direction of rotation C and are inclined with respect to the radial direction of the rotatable hammer 124. The hammer surfaces 312 are inclined by angle X as shown in FIG. 5. In some examples the angle of inclination of the hammer surfaces 312 with respect to the radial direction is between 5 degrees and 50 degrees. In some examples the angle of inclination of the hammer surfaces 312 with respect to the radial direction is between 10 degrees and 45 degrees. Alternatively, the angle of inclination of the hammer surfaces 312 with respect to the radial direction is 5, 10, 15, 20, 25, 30, 25, 40, 45, or 50 degrees or any suitable any between 5 and 50 degrees. In some examples the angle of inclination of the hammer surfaces 312 is 40 degrees. By inclining the hammer surfaces 312, the hammer surfaces 312 providing a camming action against the rotatable anvil 126 as well as exerting an impact against the anvil surfaces 400.

As mentioned above, the rotatable hammer 124 provides a camming action against the rotatable anvil 126. The rotatable hammer 124 achieves this with a cam surface 520 (best shown in FIG. 10) defined by the profile of the internal surface 316 and the elongate ridges 314. The hammer surfaces 312 are formed as part of the cam surface 520.

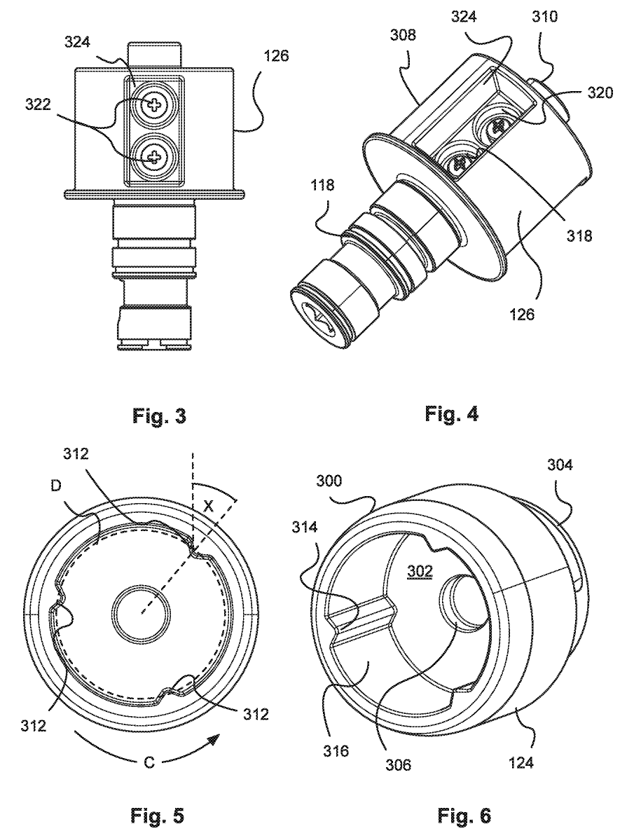

The rotatable anvil 126 and interaction with the rotatable hammer 124 will now be discussed in more detail with reference to FIGS. 3, 4, 7 and 8. The rotatable anvil 126 comprises a plurality of reciprocal anvil surfaces 400 as shown in FIG. 8. During operation of the impact mechanism 116, the hammer surface 312 is configured to strike the anvil surface 400 in order to transmit the impact torque to the tool holder 118.

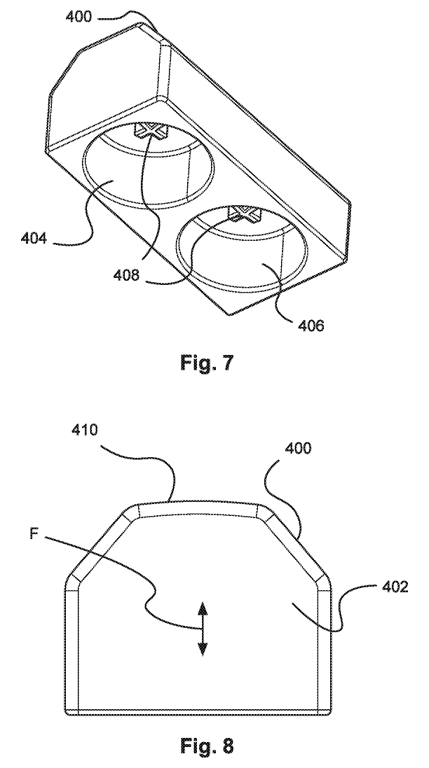

The rotatable anvil 126 will now be discussed in more detail with reference to FIGS. 3, 4, 7 and 8. FIGS. 3 and 4 respectively show a plan view and a perspective view of the rotatable anvil 126. FIGS. 7 and 8 respectively show a perspective view and an end -on view of an anvil slider 402 component of the rotatable anvil 126.

The rotatable anvil 126 comprises a plurality of anvil sliders 402 which are configured to cam against the cam surface 520 and move with respect to the anvil body portion 308. Each anvil slider 402 comprises an anvil surface 400 configured to be struck by the reciprocal hammer surface 312 on the rotatable hammer 124. The anvil slider 402 is seated in a slider recess 324. The anvil slider 402 and the anvil surface 400 are configured to move with respect to the anvil body portion 308 in a radial direction F perpendicular to the direction of rotation C. The radial direction F of the movement of the anvil slider 402 is shown in FIGS. 4 and 10.

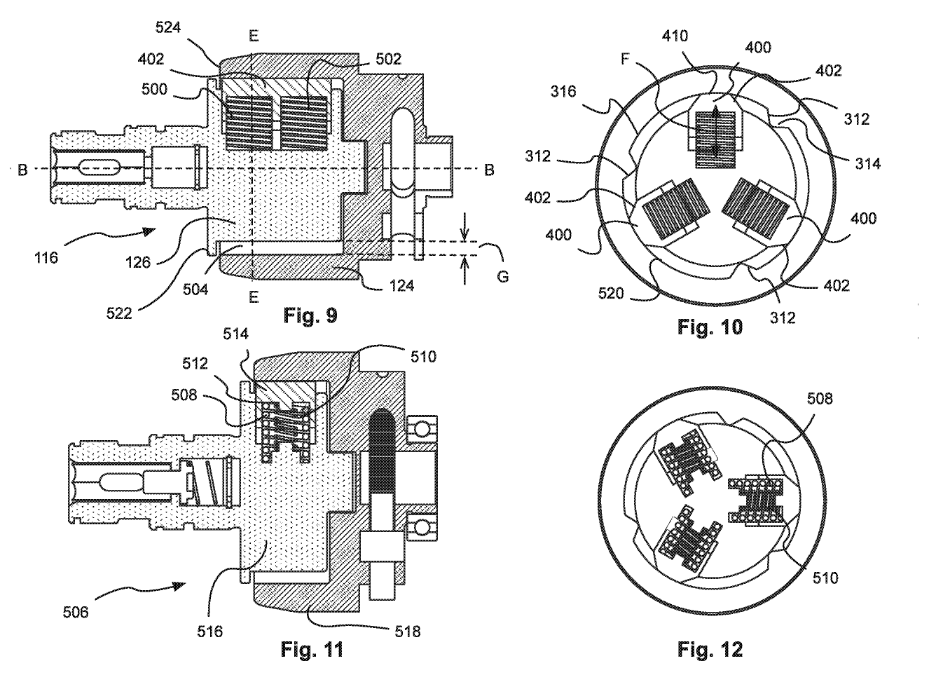

The anvil slider 402 comprises a first and second slider spring recess 404, 406 configured to receive first and second anvil return springs 500, 502 (best shown in FIG. 9). In some examples the first and second anvil return springs 500, 502 are compression springs. In other examples, the first and second anvil return springs 500, 502 can be any other suitable spring for biasing the anvil slider 402 to the first position. Whilst FIGS. 7, and 9 show recesses for first and second anvil return springs 500, 502, in some other examples there can be only a first anvil return spring 500. That is each anvil slider 402 comprises a single biasing element. In other examples, there can be any suitable number of springs for biasing the anvil slider 402. The different positions of the anvil slider 402 are discussed in more detail below.

Each of the first and second slider spring recesses 404, 406 optionally comprise a first spring centring peg 408. The first spring centring pegs 408 project into the first and second slider spring recesses 404, 406 and are configured to protrude into the first and second anvil return springs 500, 502. The first spring centring pegs 408 help keep the first and second anvil return springs 500, 502 in the correct position within the first and second slider spring recesses 404, 406.

Similarly, the anvil body portion 308 also comprises first and second anvil spring recess 318, 320 each with a second spring centring peg 322. Likewise, the second spring centring pegs 322 help keep the first and second anvil return springs 500, 502 in the correct position within the first and second anvil spring recesses 318, 320.

As the rotatable hammer 124 rotates during operation, the hammer surfaces 312 rotate along a hammer surface path D. As mentioned previously, the at least anvil slider 402 is configured to move as it cams against the cam surface 520. Specifically, the anvil slider 402 is configured to move along the radial direction F towards or away from the rotation axis B-B.

The anvil slider 402 as shown in FIGS. 9 and 10 is in a first position whereby an outer anvil surface 410 is adjacent to the internal surface 316 of the sleeve portion 300. In the first position, the anvil slider 402 can freely slide against the internal surface 316 of the sleeve portion 300. The first and second anvil return springs 500, 502 are optionally fully extended or partially extended when the anvil slider 402 is in the first position. Accordingly, in some examples, the first and second anvil return springs 500, 502 do not exert a force on the anvil slider 402 towards the internal surface 316 when the anvil slider 402 is in the first position. Alternatively, in some other examples, the first and second anvil return springs 500, 502 only exert a small force on the anvil slider 402 towards the internal surface 316 when the anvil slider 402 is in the first position. In this case, the anvil slider 402 lightly exerts a force against the internal surface 316 of the sleeve portion 300 so that the rotatable hammer 124 can still freely rotate with respect to the anvil slider 402. FIGS. 9 and 10 show the internal surface 316 of the sleeve portion 300 freely sliding against the anvil slider 402.

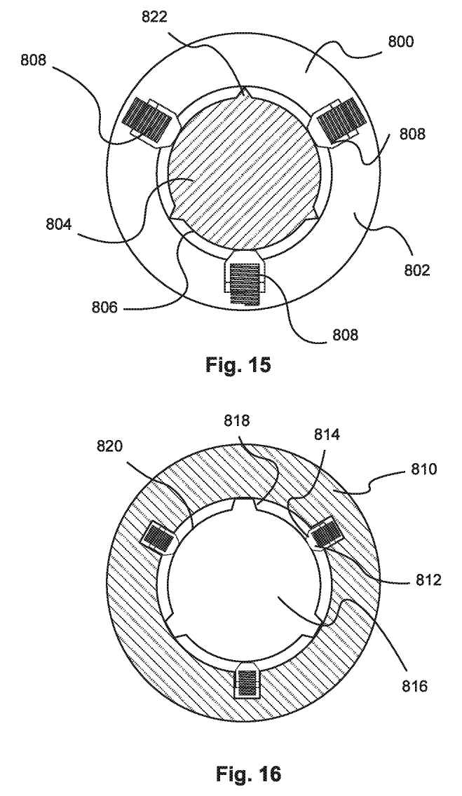

The anvil surface 400 is configured to move from the first position which is on the hammer surface path D of the hammer surfaces 312 to a second position remote from the hammer surface path D of the hammer surfaces 312. When the anvil surfaces 400 are remote from the hammer surface path D, the hammer surfaces 312 are able to move with respect to the anvil surfaces 400 along the direction of rotation C e.g. as shown in FIG. 14a. FIG. 14a will be discussed in more detail below.

FIGS. 9 and 10 respectively show a side cross-sectional view and a front cross-sectional view of the assembled impact mechanism 116. The cross-section as shown in FIG. 10 is along the axis E-E shown in FIG. 9. In FIGS. 9 and 10 the rotatable anvil 126 is inserted within the rotatable hammer 124. The anvil sliders 400 are urged to the first position and the anvil surfaces 402 are on the hammer surface path D. The hammer surfaces 312 are not engaged with the anvil surfaces 400 being rotationally displaced therefrom.

FIG. 9 shows a gap 504 between the internal surface 316 of the sleeve portion 300 and the anvil body portion 308. The anvil body portion 308 has a smaller radius than the radius of the sleeve portion 300 of the rotatable hammer 124. The width G of the gap 504 is shown in FIG. 9. The gap 504 is filled depending on the relative positions of the rotatable hammer 124 and the rotatable anvil 126. For example, the gap 504 is filled by the elongate ridge 314 when the elongate ridge 314 protrudes into the gap 504 or the anvil slider 402 protrudes into the gap 504. As can be seen from FIG. 10, both the elongate ridge 314 and the anvil slider 402 extend across the width G of the gap 504 at various locations around the impact mechanism 116.

In some examples, the distance the anvil slider 402 moves in the radial direction F between the first position and the second position is equal to or greater than the height of the elongate ridge 314. In some examples, the anvil slider 402 is configured to move a distance equal to the width G of the gap 504.

In some examples, optionally the gap 504 is filled completely or partially with grease or other suitable lubricant to reduce the friction between the rotatable hammer 124 and the rotatable anvil 126, including the anvil slider 402.

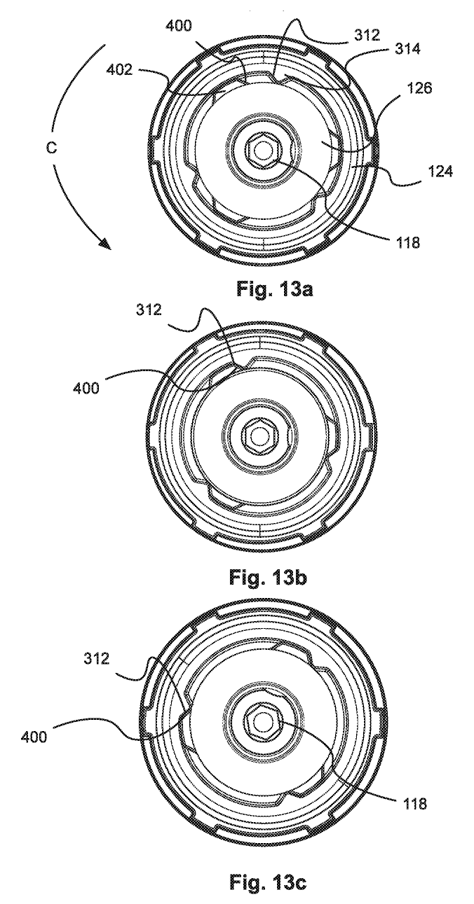

FIGS. 9 and 10 show the first and second anvil return springs 500, 502 arranged side by side along the rotational axis B-B. In another arrangement there is a modified impact mechanism 506 as shown in FIGS. 11 and 12. FIGS. 11 and 12 respectively show a side cross-sectional view and a front cross-sectional view of the assembled modified impact mechanism 506.

The modified impact mechanism 506 is the same as the impact mechanism 116 as shown in FIGS. 9 and 10 except that the modified impact mechanism 506 comprises a shorter length in the direction of the rotation axis B-B. The power tool 100 using the modified impact mechanism 506 operates in the same way as discussed in reference to the impact mechanism 116. The length of the modified impact mechanism 506 is achieved by making the modified impact mechanism 506 more compact.

The modified impact mechanism 506 comprises a compound spring assembly 512. The compound spring assembly 512 comprises a third and a fourth anvil return spring 508, 510. The fourth anvil return spring 510 is nested within the third anvil return spring 508. The third and fourth anvil return springs 508, 510 are located within the same recess in the anvil slider 402. Both the third and fourth anvil return springs 508, 510 are compressed when the anvil slider 402 moves from the first position to the second position as shown.

This means that a biasing force on the anvil slider 402 can be provided in a smaller form because the volume of the compound spring assembly 512 is smaller than the combined volume of the first and second anvil return springs 500, 502. This means that the length of the modified anvil slider 514 and the modified anvil boy portion 516 of the rotatable anvil 126, and the modified sleeve 518 of the rotatable hammer 124 in the direction of the rotational axis B-B can be reduced. The third and fourth anvil return springs 508, 510 do not provide the same force as the first and second anvil return springs 500, 502 since the fourth anvil return spring 510 is smaller than the first, second and third anvil return springs 500, 502, 508.

In some other examples, the first and second anvil return springs 500, 502 are replaced each with a compound spring assembly 512. That is, each of the first and second anvil return springs 500, 502 are replaced with a third and fourth anvil return spring 508, 510. This can increase the return force exerted on the anvil slider 402.

Whilst the Figures disclose the first, second, third and fourth anvil return springs 500, 502, 508, 510 as compression springs, in other examples, the first, second, third and fourth anvil return springs 500, 502, 508, 510 can be any other suitable biasing means. E.g. a different type of spring, a resilient biasing element, a torsion spring, a leaf spring etc.

As shown in FIGS. 9, 10, 11 and 12, all of the first, second, third and fourth anvil return springs 500, 502, 508, 510 are cylindrical and have a constant radius across along their longitudinal length. This means that the return force exerted is linearly proportional to the amount that the first, second, third and fourth anvil return springs 500, 502, 508, 510 are compressed. In some examples, compound spring assembly 512 can be modified such that either the third anvil return spring 508 or the fourth anvil return spring 510 provide a return force which is not linearly proportional to the amount that the third or fourth anvil return springs 508, 510 are compressed. In some examples, the third anvil return spring 508 or the fourth anvil return spring 510 have a conical or frustoconical shape.

In some examples, the rotatable anvil 126 comprises a projecting rib 522. The projecting rib 522 extends around the circumference of the rotatable anvil 522 and is configured to overlap with a portion of the rotatable hammer 124. In some examples, the projecting rib 522 optionally engages an end surface 524 of the rotatable hammer 124. However in other examples, the projecting rib 522 can be axially separately along the rotation axis B-B. The projecting rib 522 is configured to close the internal hammer recess 302. Accordingly, the projecting rib 522 is configured to keep grease or oil within the internal hammer recess 302. This allows the rotatable hammer 124 and the rotatable anvil 522 to rotate smoothly.

Operation of the power tool 100 will now be discussed in reference to FIGS. 13a, 13b, 13c, 14a, and 14b.

In some examples, the power tool 100 is optionally operable in a first mode and second mode. In the first mode, the power tool 100 is operable in a drill mode and in the second mode the power tool 100 is operable in an impact mode. The drill mode and the impact mode will be discussed in more detail below. In some other examples, the drill mode is optional and the power tool 100 is operable only in the impact mode.

The drill mode will be discussed with reference to FIGS. 13a, 13b, 13c which show a front view of the impact mechanism 116 with the rotatable hammer 124 and the rotatable anvil 126 in different rotational positions. For the purposes of clarity only a single hammer surface 312 and anvil surface 400 will be labelled. However, the functionality discussed herein is applicable to all the anvil surfaces 400 and the hammer surfaces 312.

In the drill mode, the power tool 100 is configured to turn the tool holder 118 without activating the impact mechanism 116. In FIG. 13a the rotatable hammer 124 is rotating about the rotational axis in the rotational direction C. At the same time, since the power tool 100 has just started, the rotatable anvil 126 is stationary. The elongate ridge 314 rotates towards the anvil slider 402 in the rotational direction C. This means that the hammer surface 312 rotates towards the anvil surface 400 as well.

FIG. 13b shows the point whereby the rotatable hammer 124 has rotated with respect to the rotatable anvil 126 from the position as shown in FIG. 13a. Now the hammer surface 312 is in engagement with the anvil surface 400. However, in the drill mode the torque exerted is not sufficient to cause the hammer surface 312 to cam against the anvil surface 400 and deflect the anvil slider 402. The anvil slider 402 remains in the first position.

FIG. 13c shows the hammer surface 312 is still in engagement with the anvil surface 400. The rotatable hammer 124 then pushes the rotatable anvil 126 in the rotational direction C. This also causes the tool holder 118 to also rotate in the rotational direction C. For example, the tool holder 118 as shown in FIG. 13c is rotated in the rotational direction C when compared with FIG. 13a. So long as the torque applied remains at the same level, the power tool 100 will continue to operate in the same drill mode. That is, the hammer surface 312 continues to push the anvil surface 400 and the rotatable anvil 126 in the rotation direction C.

The impact mode will be discussed with reference to FIGS. 13a, 13b, 14a, 14b which also show a front view of the impact mechanism 116 with the rotatable hammer 124 and the rotatable anvil 126 in different rotational positions. When the power tool 100 is actuated, the power tool 100 will rotate the rotatable hammer 124 in the same way as discussed above with reference to FIGS. 13a and 13b.

However, when the hammer surface 312 is in engagement with the anvil surface 400 as shown in FIG. 13b the impact mechanism 116 is actuated when the power tool 100 is operating in the impact mode. In the impact mode the torque exerted is sufficient to cause the hammer surface 312 to cam against the anvil surface 400 and deflect the anvil slider 402.

The impact of the hammer surface 312 striking the anvil surface 400 causes the rotatable anvil 126 to rotate in the rotational direction C. The rotation of the rotatable anvil 126 only occurs for a small distance during the impact mode.

As the hammer surface 312 cams against the anvil surface 400, the anvil slider 402 is pushed into the slider recess 324 and the anvil slider 402 moves from the first position to the second position. The elongate ridge 314 pushes the anvil slider 402 fully into the slider recess 324 as shown in FIG. 14a. At this point, the elongate ridge 314 can rotate with respect to the anvil slider 402 and the elongate ridge 314 engages the outer anvil surface 410 of the anvil slider 402 at this point. Since the rotatable hammer 124 and the elongate ridge 314 is moving past the anvil slider 402, the rotatable anvil 126 is no longer rotating.

As the hammer surface 312 moves completely past the anvil slider 402, the anvil slider 402 is no longer camming against the elongate ridge 314. Accordingly, the first and second anvil return springs 500, 502 urge the anvil slider 402 from the second position to the first position. As shown in FIG. 14b, the hammer surface 312 continues to rotate to the next anvil surface 400a to generate the next impact.

In order for the power tool 100 to operate in the impact mode, the torque exerted needs to exceed a predetermined torque threshold. The torque threshold can be modified by changing the size, material and shape of the first and second anvil return springs 500, 502. This can change the force exerted on the anvil slider 402 and how much force is required to move the anvil slider 402 from the first position to the second position. Other modifications can be made to the camming surface 520 e.g. the hammer surface 312 or the anvil surface 400 e.g. the angle of inclination X. Increasing the angle of inclination X can reduce the torque threshold.

The power tool 100 as described in reference to the Figures provides an improved impact mechanism 116. In particular, the impact mechanism 116 comprises fewer components since the camming and striking action of the hammer surface 312 on the anvil surface 400 is a result of the shape of the components of the impact mechanism 116. This means that the impact mechanism 116 is simpler and easier to assemble during manufacture. This also means that the transmission is more efficient since there are fewer components to absorb energy. This means that the power tool 100 has lower vibration and noise during operation.

As shown in the Figures, the impact mechanism 116 comprises three hammer surfaces 312 and three anvil sliders 402 each having an anvil surface 400. The three hammer surfaces 312 are circumferentially spaced around the rotatable hammer 124. In some examples, the three hammer surfaces 312 are equally circumferentially spaced around the rotatable hammer 124 e.g. angularly offset by 120 degrees. Likewise, the three anvil sliders 402 are circumferentially spaced around the rotatable anvil 126. In some examples, the three anvil sliders 402 are equally circumferentially spaced around the rotatable anvil 126 e.g. angularly offset by 120 degrees. In some examples, both the hammer surfaces 312 and the anvil sliders 402 are angularly offset by the same amount e.g. 120 degrees. This means that the three hammer surfaces 312 engage the anvil surfaces 400 at the same time. This can create a high torque transmitted to the tool holder 118.

In some other examples there can be a different number of hammer surfaces 312 and anvil sliders 402. For example, there can be any number of hammer surfaces 312 and anvil sliders 402. In some examples there is a single hammer surface 312 and single anvil slider 402 with an anvil surface 400. In some other examples there are 2, 4, 5, etc hammer surfaces 312 and anvil sliders 402 each with an anvil surface 400.

In some examples, there can be a different number of hammer surfaces 312 to the number of anvil sliders 402. That is, there can be a greater number of hammer surfaces 312 than anvil sliders 402.

As described in reference to the Figures, the rotatable anvil 126 is rotatably mounted within the sleeve portion 300 of the rotatable hammer 124. In this way, the camming surface 520 is provided on the internal surface 316 of the sleeve portion 300. However, in another example as shown in FIG. 15, the rotatable anvil 800 can comprise an anvil sleeve 802 having a greater diameter than the rotatable hammer 804. In this case, an outer camming surface 806 is provided by the rotatable hammer 804 e.g. by the elongate ridges 822 which are located on the outside e.g. the outer camming surface 806 of the rotatable hammer 804. The anvil sliders 808 are mounted within the anvil sleeve 802 of the rotatable anvil 800 and urged towards the outer camming surface 806 of the rotatable hammer 804 towards the rotation axis B-B.

In yet another example as shown in FIG. 16, which may be less preferred, a rotatable hammer 810 may comprise a hammer slider 812 having a hammer surface 814. In this case, the rotatable anvil 816 comprises fixed anvil surfaces 818 and the rotatable anvil 816 provides an anvil camming surface 820 for the hammer sliders 812. As shown in FIG. 16 there are no anvil sliders 402, only hammer sliders 812. Accordingly, the hammer sliders 812 cam against an anvil camming surface 820 the rotatable anvil 816.

In another example, two or more examples are combined. Features of one example can be combined with features of other examples.

Examples of the present disclosure have been discussed with particular reference to the examples illustrated. However, it will be appreciated that variations and modifications may be made to the examples described within the scope of the disclosure.

1. A power tool comprising:
a housing;
a motor having a drive shaft mounted in the housing;
an impact mechanism mounted in the housing and coupled to a tool holder; the impact mechanism comprising:
a rotatable hammer operatively connected to the drive shaft and having at least one hammer surface; and
a rotatable anvil connected to the tool holder and having at least one anvil surface configured to be struck by the at least one hammer surface in a direction of rotation;
wherein the at least one anvil surface or the at least one hammer surface is moveable with respect to the other of the at least one hammer surface or the at least one anvil surface in a radial direction perpendicular to the direction of rotation.

2. The power tool according to claim 1, wherein the rotatable hammer comprises a rotatable sleeve.

3. The power tool according to claim 2, wherein the at least one hammer surface is mounted on an inner surface of the rotatable sleeve.

4. The power tool according to claim 2, wherein the rotatable anvil comprises a cylindrical body portion rotatably mountable within the rotatable sleeve.

5. The power tool according to claim 4, wherein the at least one anvil surface is mounted on an outer surface of the cylindrical body portion.

6. The power tool according to claim 1, wherein the rotatable hammer comprises a plurality of hammer surfaces circumferentially spaced around the rotatable hammer.

7. The power tool according to claim 6, wherein the rotatable anvil comprises a plurality of anvil surfaces circumferentially spaced around the rotatable anvil.

8. The power tool according to claim 7, wherein the impact mechanism comprises the same number of hammer surfaces and anvil surfaces.

9. The power tool according to claim 1, wherein the rotatable anvil comprises at least one anvil slider having the at least one anvil surface.

10. The power tool according to claim 9, wherein the at least one anvil slider is mounted in a recess in the rotatable anvil.

11. The power tool according to claim 9, wherein the at least one anvil slider is configured to move from a first position in a path of the at least one hammer surface to a second position remote from the path the at least one hammer surface such that the at least one hammer surface moves with respect to the at least one anvil surface.

12. The power tool according to claim 11, wherein the at least one anvil slider in the second position is closer to a rotation axis of the rotatable anvil than in the first position.

13. The power tool according to claim 11, wherein the at least one anvil slider comprises at least one spring configured to bias the at least one anvil slider towards the first position.

14. The power tool according to claim 1, wherein the at least one hammer surface and / or the at least one anvil surface are inclined with respect to the direction of rotation.

15. The power tool according to claim 1, wherein the impact mechanism is operable in an impact mode whereby the at least one anvil surface or the at least one hammer surface moves with respect to the other of the at least one hammer surface or the at least one anvil surface in a radial direction perpendicular to the direction of rotation and a drill mode whereby the at least one anvil surface engages the at least one hammer surface and the rotatable hammer and rotatable anvil rotate together.

16. The power tool according to claim 15, wherein the impact mechanism is configured to operate in the impact mode when a torque on the tool holder exceeds a predetermined torque threshold.

17. An impact mechanism for a power tool, the impact mechanism comprising:
a rotatable hammer operatively connectable to a drive shaft of a power tool motor and having at least one hammer surface; and
a rotatable anvil connectable to a tool holder and having at least one anvil surface configured to be struck by the at least one hammer surface in a direction of rotation;
wherein the at least one anvil surface or the at least one hammer surface is moveable with respect to the other of the at least one hammer surface or the at least one anvil surface in a radial direction perpendicular to the direction of rotation.

18. The power tool according to claim 17, wherein the rotatable anvil comprises at least one anvil slider having the at least one anvil surface.

19. The power tool according to claim 18, wherein the at least one anvil slider is mounted in a recess in the rotatable anvil.
